(19) United States
(12) Patent Application Publication
(10) Pub. No.: US 2010/0033753 A1
(43) Pub. Date: Feb. 11, 2010

(54) SYSTEM AND METHOD FOR SELECTIVE REDACTION OF SCANNED DOCUMENTS

(76) Inventor: Kenneth STEPHENSON, San Clemente, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/186,558

(22) Filed: Aug. 6, 2008

(51) Int. Cl. G06F 3/12

(52) U.S. Cl. 358/1.15

(57) ABSTRACT

The subject application is directed to a system and method for selective redaction of scanned documents. A tangible document is scanned so as to generate electronic image data, and an image of the tangible document is generated on an associated touch screen display in accordance with the electronic image data. Tactile input is received on a first area of the touch screen corresponding to a first perimeter portion of a selected redaction boundary area and on a second area of the touch screen corresponding to a second perimeter portion of the selected redaction boundary area. Image data is then obfuscated corresponding to the selected redaction boundary area. The touch screen display is updated such that image data is hidden in the selected redaction boundary area, and image data inclusive of obfuscated image data in the selected redaction boundary area is stored in an associated memory.

### BACKGROUND OF THE INVENTION

The subject application is directed generally to redaction of documents. The application is particularly applicable to redaction of information on scanned documents.

It is frequently desirable to convert tangible documents to electronic documents, such as bitmapped image data. This conversion is done via a scanner. Modern data copiers employ scanners, as well as functionality to immediately create a tangible output from a scanned document.

It is frequently desirable to mask one or more portions of a document from scanning or reproduction. By way of example, it may be desirable to reproduce a credit card statement as proof of payment. However, such reproduction may result in an image that exposes much more confidential information than is warranted for a particular situation.

### SUMMARY OF THE INVENTION

In accordance with one embodiment of the subject application, there is provided a document processing system and method for selective redaction of scanned documents. A tangible document is scanned so as to generate electronic image data corresponding thereto, and an image of the tangible document is generated on an associated touch screen display in accordance with the generated electronic image data. Tactile input is received on a first area of the touch screen corresponding to a first perimeter portion of a selected redaction boundary area and on a second area of the touch screen corresponding to a second perimeter portion of the selected redaction boundary area. Image data is then obfuscated corresponding to the selected redaction boundary area. The touch screen display is updated such that image data is hidden in the selected redaction boundary area, and image data inclusive of obfuscated image data is stored in the selected redaction boundary area in an associated memory.

Still other advantages, aspects, and features of the subject application will become readily apparent to those skilled in the art from the following description, wherein there is shown and described a preferred embodiment of the subject application, simply by way of illustration of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for selective redaction of scanned documents according to one embodiment of the subject application;

FIG. 2 is a block diagram illustrating device hardware for use in the system for selective redaction of scanned documents according to one embodiment of the subject application;

FIG. 3 is a functional diagram illustrating the device for use in the system for selective redaction of scanned documents according to one embodiment of the subject application;

FIG. 4 is a block diagram illustrating controller hardware for use in the system for selective redaction of scanned documents according to one embodiment of the subject application;

FIG. 5 is a functional diagram illustrating the controller for use in the system for selective redaction of scanned documents according to one embodiment of the subject application;

FIG. 6 is a block diagram illustrating the system for selective redaction of scanned documents according to one embodiment of the subject application;

FIG. 7 is a functional diagram illustrating the system for selective redaction of scanned documents according to one embodiment of the subject application;

FIG. 8A is an example tangible input document for use in the system for selective redaction of scanned documents according to one embodiment of the subject application;

FIG. 8B is an example tangible input document depicting the selection of a redacted boundary area in the system for selective redaction of scanned documents according to one embodiment of the subject application;

FIG. 8C is an example tangible input document depicting selected redaction boundaries in the system for selective redaction of scanned documents according to one embodiment of the subject application;

FIG. 8D is an example output document illustrating redacted areas in the system for selective redaction of scanned documents according to one embodiment of the subject application;

FIG. 9 is a flowchart illustrating a method for selective redaction of scanned documents according to one embodiment of the subject application; and

FIG. 10 is a flowchart illustrating a method for selective redaction of scanned documents according to one embodiment of the subject application.

### DETAILED DESCRIPTION OF THE PREFERRED EMBODIMENT

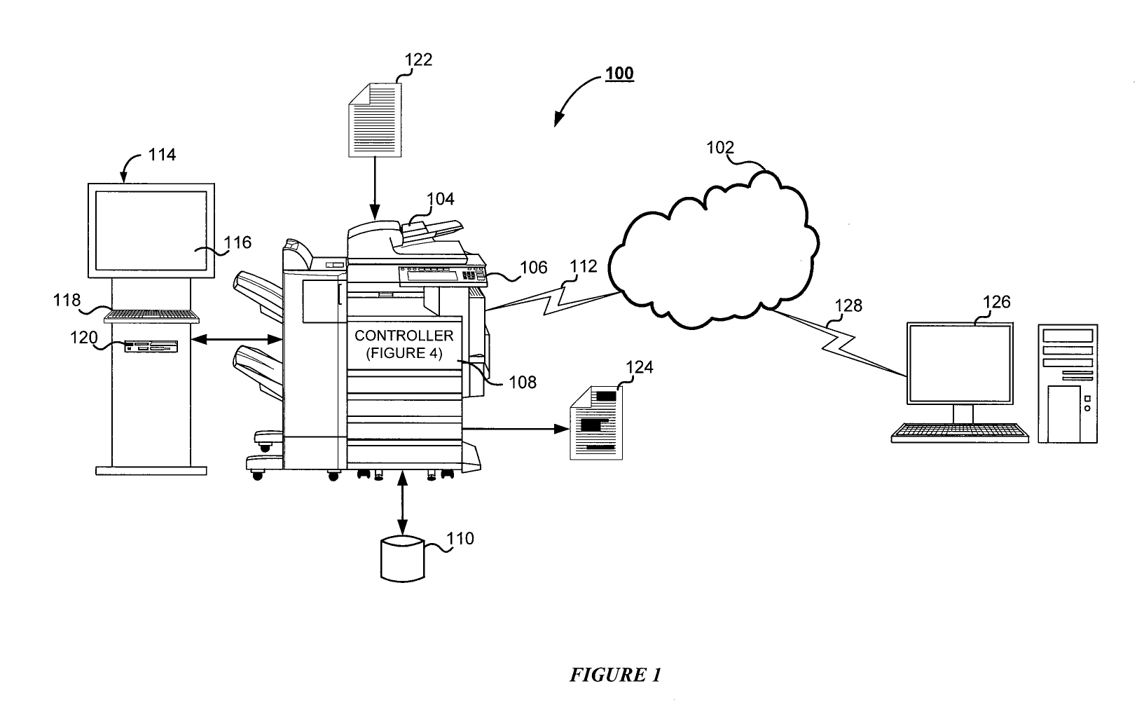

The subject application is directed to a system and method for redaction of documents. In particular, the subject application is directed to a system and method for selectively redacting information on scanned documents. It will become apparent to those skilled in the art that the system and method described herein are suitably adapted to a plurality of varying electronic fields employing image manipulation including, for example and without limitation, communications, general computing, data processing, document processing, financial transactions, vending of products or services, and the like. The preferred embodiment, as depicted in FIG. 1, illustrates a document processing field for example purposes only and is not a limitation of the subject application solely to such a field.

Referring now to FIG. 1, there is shown an overall diagram of a system 100 for selective redaction of scanned documents in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art that is capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad conventional data transport mechanisms such as, for example and without limitation, Token-Ring, 802.11(x), Ethernet, or other wireless or wire-based data communication mechanisms. The skilled artisan will appreciate that, while a computer network 102 is shown in FIG. 1, the subject application is equally capable of use in a stand-alone system, as will be known in the art.

The system 100 also includes a document processing device 104, which is depicted in FIG. 1 as a multifunction peripheral device suitably adapted to perform a variety of document processing operations. It will be appreciated by those skilled in the art that such document processing operations include, for example and without limitation, facsimile, scanning, copying, printing, electronic mail, document management, document storage, and the like. Suitable commercially-available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof configured to interact with an associated user, a networked device, or the like.

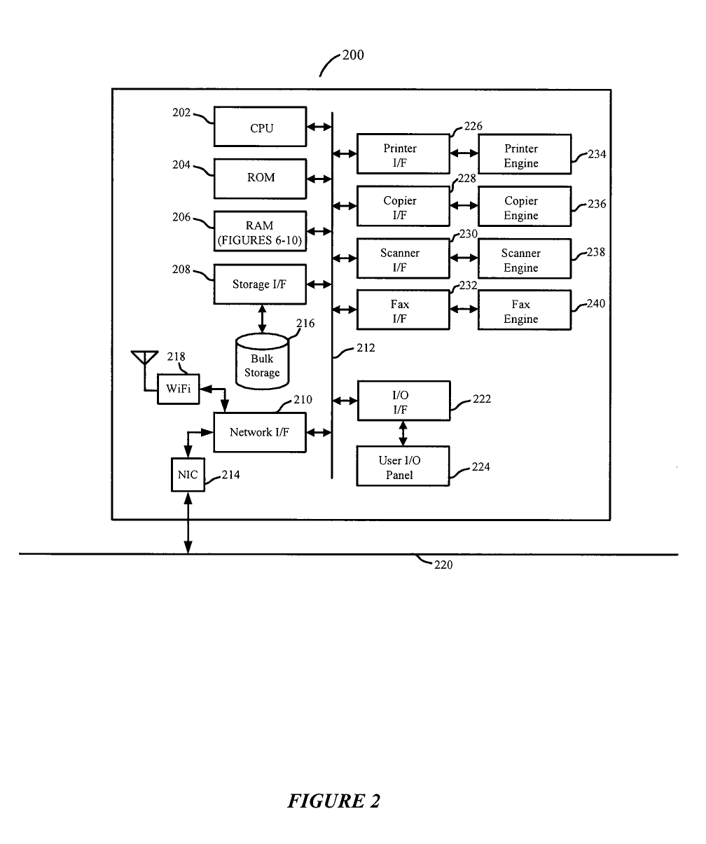

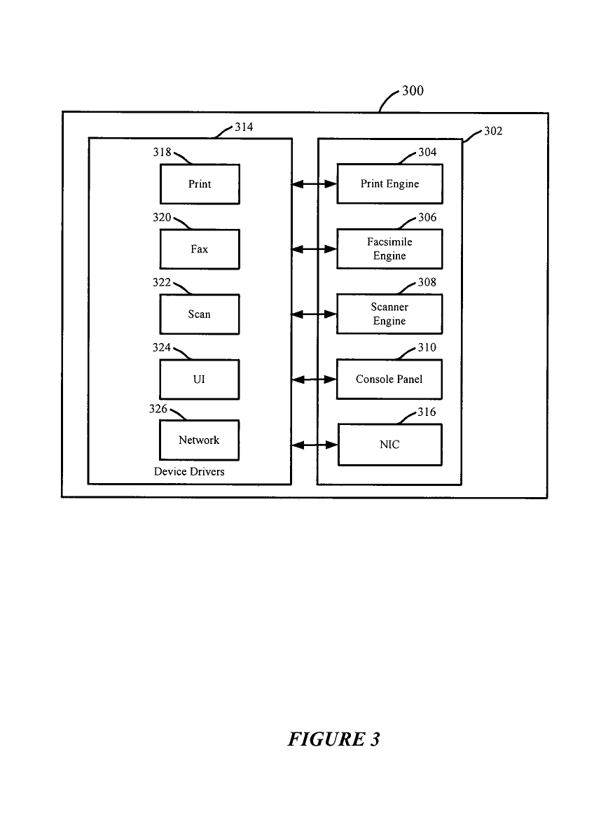

According to one embodiment of the subject application, the document processing device 104 is suitably equipped to receive a plurality of portable storage media including, without limitation, Firewire drive, USB drive, SD, MMC, XD, compact flash, memory stick, and the like. In the preferred embodiment of the subject application, the document processing device 104 further includes an associated user interface 106, such as a touch screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and to receive selections from the associated user. The skilled artisan will appreciate that the user interface 106 comprises various components suitably adapted to present data to the associated user, as are known in the art. In accordance with one embodiment of the subject application, the user interface 106 comprises a display suitably adapted to display one or more graphical elements, text data, images, or the like to an associated user, to receive input from the associated user, and to communicate the same to a backend component such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

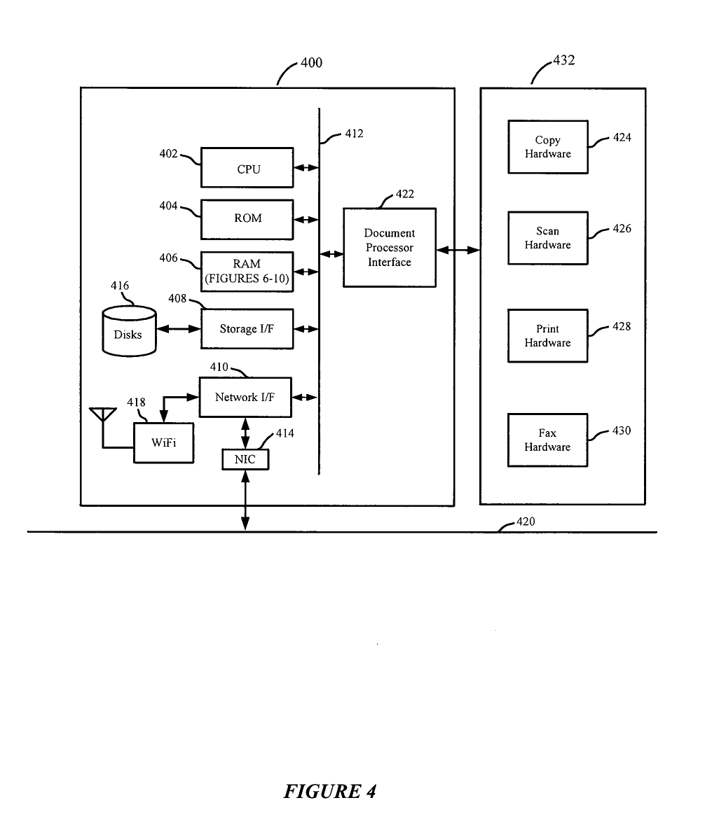

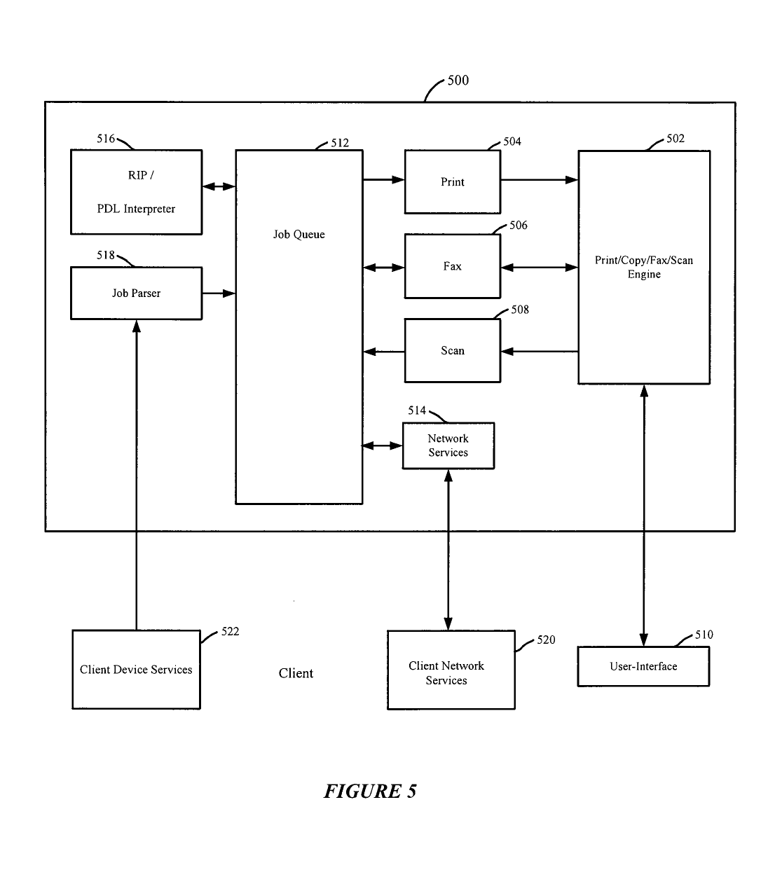

In accordance with one embodiment of the subject application, the document processing device 104 incorporates a backend component, designated as the controller 108, suitably adapted lo to facilitate the operations of the document processing device 104, as will be understood by those skilled in the art. Preferably, the controller 108 is embodied as hardware, software, or any suitable combination thereof configured to control the operations of the associated document processing device 104, to facilitate the display of images via the user interface 106, to direct the manipulation of electronic image data, and the like. For purposes of explanation, the controller 108 is used to refer to any of the myriad components associated with the document processing device 104, including hardware, software, or combinations thereof functioning to perform, cause to be performed, control, or otherwise direct the methodologies described hereinafter. It will be understood by those skilled in the art that the methodologies described with respect to the controller 108 are capable of being performed by any general purpose computing system known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the system and method for selective redaction of scanned documents. The functioning of the controller 108 will be better understood in conjunction with the block diagrams illustrated in FIGS. 4 and 5, explained in greater detail below.

Communicatively coupled to the document processing device 104 is a data storage device 110. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In one embodiment, the data storage device 110 is suitably adapted to store scanned image data, modified image data, redacted data, user information, cellular telephone data, pre-set payment data, document data, image data, electronic database data, or the like. It will be appreciated by those skilled in the art that, while illustrated in FIG. 1 as being a separate component of the system 100, the data storage device 110 is capable of being implemented as an internal storage component of the document processing device 104, a component of the controller 108, or the like such as, for example and without limitation, an internal hard disk drive or the like. In accordance with one embodiment of the subject application, the data storage device 110 is capable of storing document processing instructions, usage data, user interface data, job control data, controller status data, component execution data, images, advertisements, user information, location information, output templates, mapping data, multimedia data files, fonts, and the like.

FIG. 1 also illustrates a kiosk 114 communicatively coupled to the document processing device 104 and, in effect, the computer network 102. It will be appreciated by those skilled in the art that the kiosk 114 is capable of being implemented as a separate component of the document processing device 104 or as an integral component thereof. Use of the kiosk 114 in FIG. 1 is for example purposes only, and the skilled artisan will appreciate that the subject application is capable of implementation without the use of the kiosk 114. In accordance with one embodiment of the subject application, the kiosk 114 includes an associated display 116 and a user input device 118. As will be understood by those skilled in the art the kiosk 114 is capable of implementing a combination user input device/display, such as a touch screen interface. According to one embodiment of the subject application, the kiosk 114 is suitably adapted to display prompts to an associated user, to receive document processing instructions from the associated user, to receive payment data, to receive selection data from the associated user, and the like. Preferably, the kiosk 114 includes a magnetic card reader, conventional bar code reader, or the like suitably adapted to receive and read payment data from a credit card, coupon, debit card, or the like.

The system 100 of FIG. 1 also includes a portable storage device reader 120 coupled to the kiosk 114, which is suitably adapted to receive and access myriad different portable storage devices. Examples of such portable storage devices include, for example and without limitation, flash-based memory such as SD, xD, memory stick, compact flash, CD-ROM, DVD-ROM, USB flash drives, or other magnetic or optical storage devices, as will be known in the art.

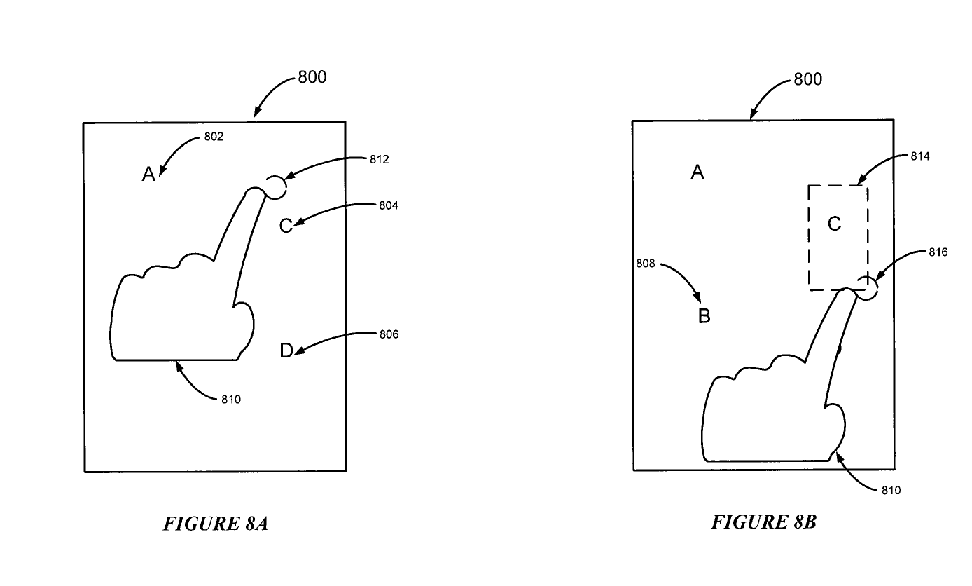

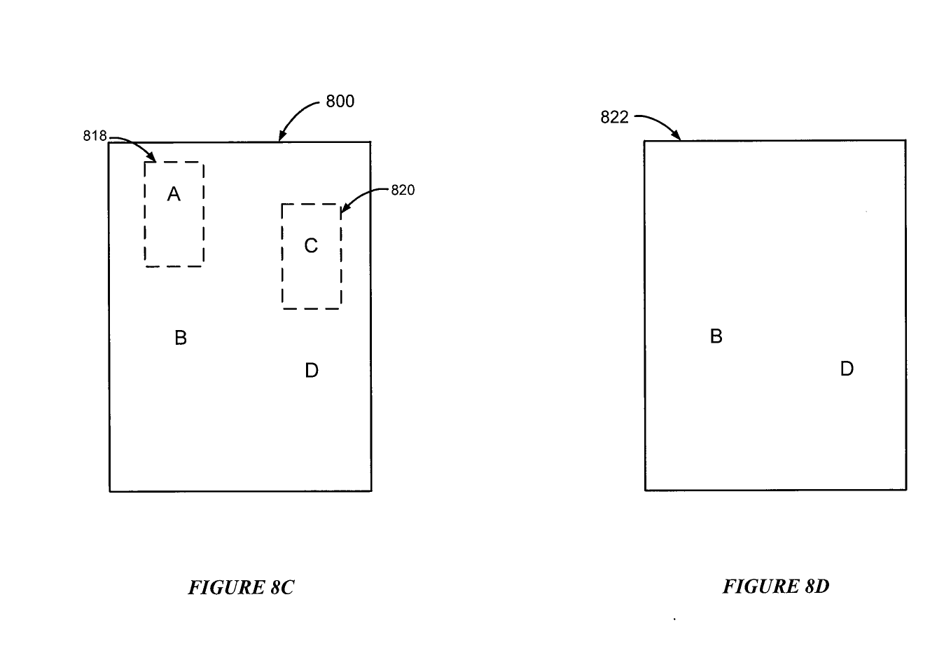

The system 100 illustrated in FIG. 1 further includes an input document 122 and a redacted output document 124. The skilled artisan will appreciate that, while illustrated in tangible form, the input document 122 and the output document 124 are capable of being rendered electronically, i.e. communicated from a user device 126, received via facsimile operations of the document processing device 104, retrieved from a portable storage device, or the like. Additional examples of such input and output documents 122 and 124 are illustrated in FIGS. 8A-8D, discussed in greater detail below.

Depicted in FIG. 1 is a user device 126, illustrated as a personal computer in data communication with the computer network 102 via a communications link 128. It will be appreciated by those skilled in the art that the user device 126 is shown in FIG. 1 as a computer workstation for illustration purposes only. As will be understood by those skilled in the art, the user device 126 is representative of any personal computing device known in the art including, for example and without limitation, a laptop computer, a workstation computer, a personal data assistant, a web-enabled cellular telephone, a smart phone, a proprietary network device, or other web-enabled electronic device. The communications link 128 is any suitable channel of data communications known in the art including but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system or wired communications known in the art. Preferably, the user device 126 is suitably adapted to receive redacted documents, status data, job data, user interface data, and/or image data; to monitor document processing jobs; to employ thin-client interfaces; to generate display data; to generate output data; or the like with respect to the document processing device 104 or any other similar device coupled to the computer network 102.

Turning now to FIG. 2, illustrated is a representative architecture of a suitable device 200, shown in FIG. 1 as the document processing device 104, on which operations of the subject system are completed. Included is a processor 202 suitably comprised of a central processor unit. However, it will be appreciated that the processor 202 may advantageously be composed of multiple processors working in concert with one another, as will be appreciated by one of ordinary skill in the art. Also included is a non-volatile or read only memory 204, which is advantageously used for static or fixed data or instructions such as BIOS functions, system functions, system configuration data, and other routines or data used for operation of the device 200.

Also included in the device 200 is random access memory 206 suitably formed of dynamic random access memory, static random access memory, or any other suitable addressable memory system. Random access memory 206 provides a storage area for data instructions associated with applications and data handling accomplished by the processor 202.

A storage interface 208 suitably provides a mechanism for volatile, bulk, or long-term storage of data associated with the device 200. The storage interface 208 suitably uses bulk storage, such as any suitable addressable or serial storage such as a disk, optical, tape drive, and the like as shown as 216, as well as any suitable storage medium, as will be appreciated by one of ordinary skill in the art.

A network interface subsystem 210 suitably routes input and output from an associated network, allowing the device 200 to communicate to other devices. The network interface subsystem 210 suitably interfaces with one or more connections with external devices to the device 200. By way of example, illustrated is at least one network interface card 214 for data communication with fixed or wired networks such as Ethernet, Token-Ring, and the like and a wireless interface 218 suitably adapted for wireless communication via means such as WiFi. WiMax, wireless modem, cellular network, or any suitable wireless communication system. It is to be appreciated, however, that the network interface subsystem 210 suitably utilizes any physical or non-physical data transfer layer or protocol layer, as will be appreciated by one of ordinary skill in the art. In the illustration, the network interface card 214 is interconnected for data interchange via a physical network 220 suitably comprised of a local area network, wide area network, or a combination thereof.

Data communication between the processor 202, read only memory 204, random access memory 206, storage interface 208, and the network subsystem 210 is suitably accomplished via a bus data transfer mechanism, such as illustrated by the bus 212.

Suitable executable instructions on the device 200 facilitate communication with a plurality of external devices such as workstations, document processing devices, other servers, or the like. While, in operation, a typical device operates autonomously, it is to be appreciated that direct control by a local user is sometimes desirable and is suitably accomplished via an optional input/output interface 222 to a user input/output panel 224, as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device 300, depicted in FIG. 1 as the document processing device 104, for use in connection with the disclosed system 100. FIG. 3 illustrates suitable functionality of the hardware of FIG. 2 in connection with software and operating system functionality, as will be appreciated by one of ordinary skill in the art. The document processing device 300 suitably includes an engine 302, which facilitates one or more document processing operations.

The document processing engine 302 suitably includes a print engine 304, facsimile engine 306, scanner engine 308, and console panel 310. The print engine 304 allows for output of physical documents representative of an electronic document communicated to the processing device 300. The facsimile engine 306 suitably communicates to or from external facsimile devices via a device such as a fax modem.

The scanner engine 308 suitably functions to receive hard copy documents and, in turn, image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format and is also suitably configured for optical character recognition. Tangible document scanning also suitably functions to facilitate facsimile output thereof.

In the illustration of FIG. 3, the document processing engine 302 also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers 314 allow for data interchange from the document processing engine 302 to one or more physical devices to accomplish the actual document processing operations. Such document processing operations include one or more of printing via driver 318, facsimile communication via driver 320, scanning via driver 322, and user interface functions via driver 324. It will be appreciated that these various devices are integrated with one or more corresponding engines associated with the document processing engine 302. It is to be appreciated that any set or subset of document processing operations are contemplated herein. Document processors that include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device known in the art that is capable of facilitating the methodologies described herein. Included is a processor 402 suitably comprised of a central processor unit. However, it will be appreciated that processor 402 may be advantageously composed of multiple processors working in concert with one another, as will be appreciated by one of ordinary skill in the art. Also included is a non-volatile or read only memory 404, which is advantageously used for static or fixed data or instructions such as BIOS functions, system functions, system configuration data, and other routines or data used for operation of the controller 400.

Also included in the controller 400 is random access memory 406 suitably formed of dynamic random access memory, static random access memory, or any other suitable addressable and writeable memory system. Random access memory 406 provides a storage area for data instructions associated with applications and data handling accomplished by processor 402.

A storage interface 408 suitably provides a mechanism for non-volatile, bulk, or long-term storage of data associated with the controller 400. The storage interface 408 suitably uses bulk storage, such as any suitable addressable or serial storage such as a disk, optical, tape drive, and the like as shown as 416, as well as any suitable storage medium, as will be appreciated by one of ordinary skill in the art.

A network interface subsystem 410 suitably routes input and output from an associated network, allowing the controller 400 to communicate to other devices. The network interface subsystem 410 suitably interfaces with one or more connections with external devices to the device 400. By way of example, illustrated is at least one network interface card 414 for data communication with fixed or wired networks such as Ethernet, Token-Ring, and the like and a wireless interface 418 suitably adapted for wireless communication via means such as WiFi. WiMax, wireless modem, cellular network, or any suitable wireless communication system. It is to be appreciated, however, that the network interface subsystem 410 suitably utilizes any physical or non-physical data transfer layer or protocol layer, as will be appreciated by one of ordinary skill in the art. In the illustration, the network interface 414 is interconnected for data interchange via a physical network 420 suitably comprised of a local area network, wide area network, or a combination thereof.

Data communication between the processor 402, read only memory 404, random access memory 406, storage interface 408, and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4 (shown in FIG. 1 as the controller 108) as an intelligent subsystem associated with a document processing device. In the illustration of FIG. 5, controller function 500 in the preferred embodiment includes a document processing engine 502. Suitable controller functionality is that incorporated into the Toshiba e-Studio system in the preferred embodiment. FIG. 5 illustrates suitable functionality of the hardware of FIG. 4 in connection with software and operating system functionality, as will be appreciated by one of ordinary skill in the art.

In the preferred embodiment, the engine 502 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited-purpose document processing devices that perform one or more of the document processing operations listed above.

The engine 502 is suitably interfaced to a user interface panel 510, which panel 510 allows for a user or administrator to access functionality controlled by the engine 502. Access is suitably enabled via an interface local to the controller or remotely via a remote thin or thick client.

The engine 502 is in data communication with the print function 504, facsimile function 506, and scan function 508. These functions 504, 506, 508 facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network-based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506, or scan 508.

Finally, the job queue 512 is in data communication with a parser 518, which parser 518 suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

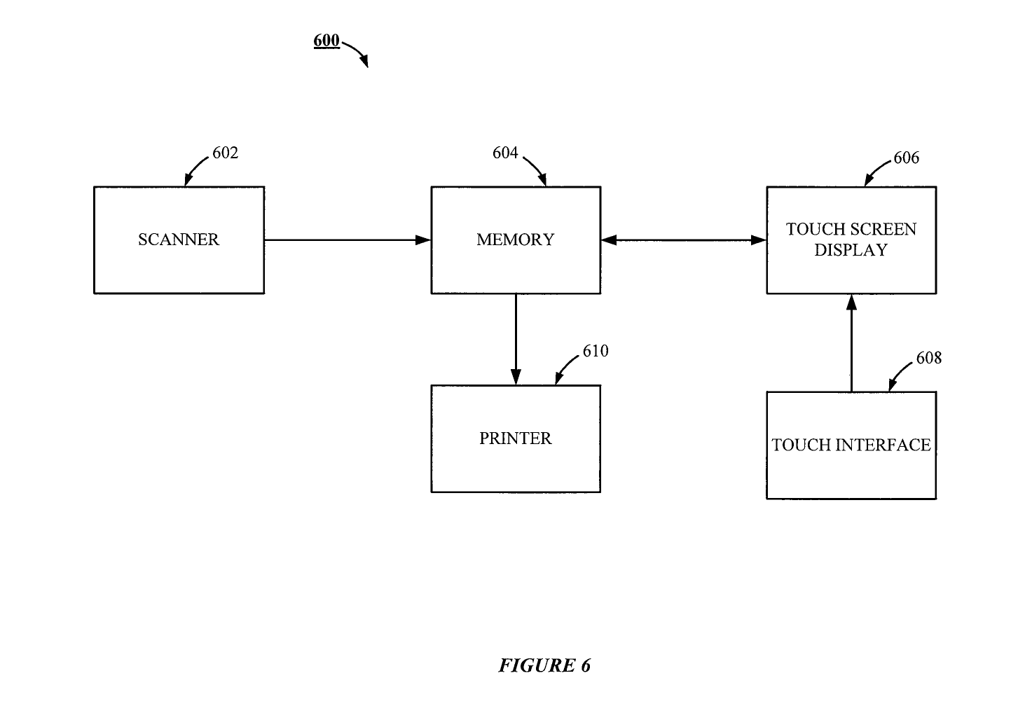

Turning now to FIG. 6, illustrated is a block diagram of a system 600 for selective redaction of scanned documents in accordance with one embodiment of the subject application. The system 600 includes a scanner 602 configured to generate image data of a tangible input document and memory 604 for storing the image data from the scanner 602. The system 600 further includes a touch screen display 606 configured to display an image of an electronic document from the scanner 602, e.g. image data of the tangible input document. The system 600 also comprises a touch interface 608 of the touch screen display 606 operable to define a redaction boundary in accordance with tactile activation of first and second areas relative to the displayed image on the display 606. The memory 604 of the system 600 is further configured to store image data altered in accordance with the defined redaction boundary area based upon the tactile activation of the touch interface 608. In addition, the system 600 includes a printer 610 operable to print redacted image data corresponding to image data stored in the associated memory 604.

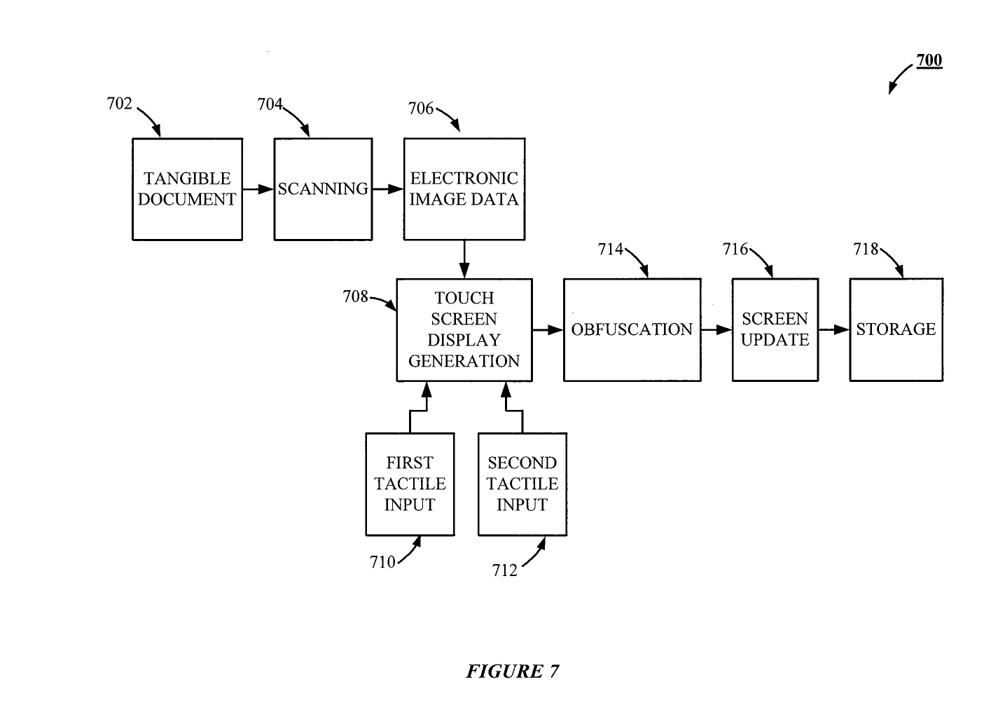

Referring now to FIG. 7, there is shown a functional diagram 700 illustrating the system for selective redaction of scanned documents in accordance with one embodiment of the subject application. A tangible document 702 is first scanned 704 so as to generate electronic image data 706 corresponding to the tangible document 702. Generation 708 of the electronic image data then occurs via the touch screen display 106, the display 116, or other suitable display device associated with the document processing device 104. First tactile input 710 on a first area of the generated touch screen display 708 is then received from an associated user corresponding to a first perimeter portion of a selected redaction boundary area. Second tactile input 712 on a second area of the generated touch screen display 708 is then received from an associated user corresponding to a second perimeter portion of a selected redaction boundary area. Obfuscation 714 is then implemented on the selected redaction boundary area so as to hide the content of the electronic document in the selected area. Screen updating 716 of the electronic image data is then performed, thereby hiding the content of the document in the selected boundary area. Image data storage 718 of the obfuscated image data in the selected redaction boundary area then occurs in associated memory.

Turning now to FIGS. 8A, 8B, 8C, and 8D, there are shown example documents processed in accordance with the system for selective redaction of scanned documents in accordance with one embodiment of the subject application. As shown in FIG. 8A, an electronic image of an input document 800 (shown in FIG. 1 as the input document 122) is generated on the touch screen display 106 or the display 116 of the kiosk 114 associated with the document processing device 104. The document 800 includes multiple text, image, graphics, or the like designated as the content 802, 804, and 806 (a fourth content not shown in FIG. 8A is depicted in the subsequent image of FIG. 8B as the reference number 808). A user 810 then selects a first perimeter portion 812 by tactile input on the display of the document 800 around the content 804 to be redacted.

FIG. 8B illustrates the second perimeter portion 816 that defines the boundary area 814 to be redacted as selected by the user 810. In accordance with one embodiment of the subject application, the user 810 drags a finger diagonally across the document 800 so as to define the boundary area 814. Other methods of selecting via the touch screen display of the document 800 will be appreciated by those skilled in the art as capable of implementation in accordance with the subject application. FIG. 8C illustrates the document 800 having two selected redacted boundary areas 818 and 820 as selected by the user 810. FIG. 8D illustrates a redacted output document 822 (shown in FIG. 1 as the output document 124), wherein the selected boundary areas 818 and 820 have been redacted in accordance with the user 810 provided selections.

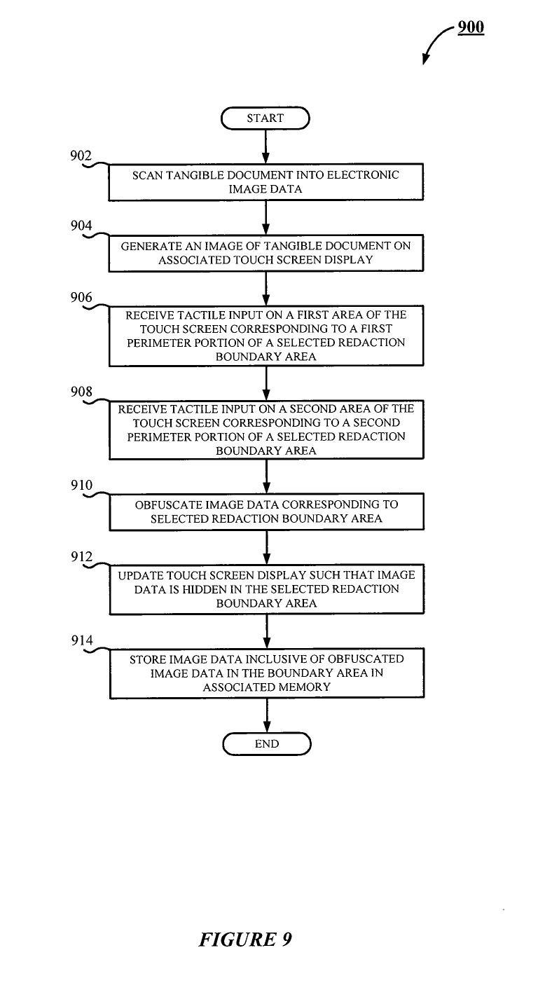

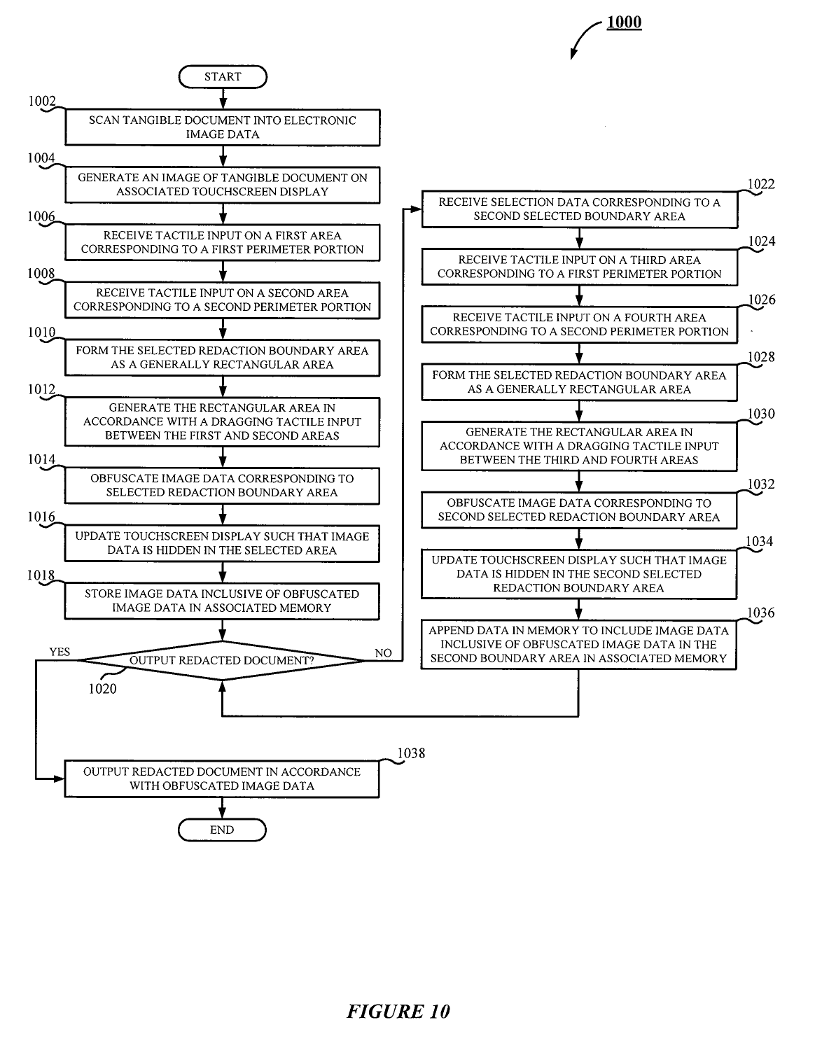

The skilled artisan will appreciate that the subject system 100 and components described above with respect to FIG. 1, FIG. 2, FIG. 3, FIG. 4, FIG. 5, FIG. 6, FIG. 7, and FIGS. 8A-8D will be better understood in conjunction with the methodologies described hereinafter with respect to FIG. 9 and FIG. 10. Turning now to FIG. 9, there is shown a flowchart 900 illustrating a method for selective redaction of scanned documents in accordance with one embodiment of the subject application. Beginning at step 902, a tangible document 122 is scanned by the document processing device 104 so as to generate electronic image data corresponding to the tangible document 122. At step 904, the controller 108 or other suitable component associated with the document processing device 104 generates an image of tile tangible document 122 on the user interface 106, the display 116, or other suitable touch screen associated with the document processing device 104 in accordance with the generated electronic image data.

Tactile input is then received from an associated user at step 906 on a first area of the touch screen 106 or 116 corresponding to a first perimeter portion of a selected redaction to boundary area. At step 908, tactile input on a second area of the touch screen 106 or 116 corresponding to a second perimeter portion of the selected redaction boundary area is received by the controller 108 or other suitable component associated with the document processing device 104 from the associated user. The controller 108 then obfuscates image data corresponding to the selected redaction boundary area at step 910. At step 912, the touch screen display 106 or 116 is updated such that image data is hidden in the selected redaction boundary area. Thereafter, at step 914, image data inclusive of obfuscated image data in the selected redaction boundary area is stored in the data storage device 110. In accordance with one embodiment of the subject application, the image data is communicated via the computer network 102 to the user device 126 for storage thereon.

Referring now to FIG. 10, there is shown a flowchart 1000 illustrating a method for selective redaction of scanned documents in accordance with one embodiment of the subject application. The methodology of FIG. 10 begins at step 1002, whereupon a tangible document 122 is first scanned by the document processing device 104 into electronic document data. It will be appreciated by those skilled in the art that such a tangible document 122 is capable of including, for example and without limitation, text, images, graphics, photographs, and the like. At step 1004 an image of the tangible document 122 is generated on a touch screen associated with the document processing device 104, e.g. the user interface 106, the touch screen display 116 of the kiosk 114, or the like (hereinafter the touch screen 106 or 116). In accordance with one embodiment of the subject application, the controller 108 or other suitable component associated with the document processing device 104 directs the touch screen 106 or 116 to display a graphical representation of the scanned tangible document 122.

At step 1006, tactile input on a first area of the touch screen 106 or 116 corresponding to a first perimeter portion of a selected redaction boundary area is received from an associated user. Tactile input on a second area of the touch screen 106 or 116 corresponding to a second perimeter portion of the selected redaction boundary area is then received from the associated user at step 1008. At step 1010, the selected redaction boundary area is formed on the touch screen 106 or 116 as a generally rectangular area defined by the tactile input in the first and second areas of the touch screen 106 or 116. The rectangular area is then generated at step 1012 in accordance with a dragging tactile input between the first and second areas of the touch screen 106 or 116. A suitable example of such action is illustrated in FIGS. 8A-8D, discussed in greater detail above.

Image data is then obfuscated by the controller 108 or other suitable component associated with the document processing device 104 at step 1014, corresponding to the selected redaction boundary area. The touch screen display 106 or 116 is then updated at step 1016 such that image data is hidden in the selected redaction boundary area, e.g. the text, graphic, photograph, or the like is hidden. Image data, inclusive of the obfuscated image data in the boundary area, is then stored in the data storage device 110 at step 1018. A determination is then made by the controller 108 or other suitable component associated with the document processing device 104 at step 1020 as to whether to output the redacted document 124. Upon a determination at step 1020 that the redacted document 124 is to be output, flow proceeds to step 1038, whereupon the redacted document 124 is output by the document processing device 104 in accordance with the obfuscated image data. It will be appreciated by those skilled in the art that such output is capable of including, for example and without limitation, printing the redacted output document 124, communicating such redacted output document 124 to the user device 126, facsimile transmitting the document 124 to a designated recipient, or the like.

Returning to step 1020, when it is determined that a redacted document is not to be output, flow progresses to step 1022, whereupon selection data is received for at least a second redaction boundary area of the tangible document 122 displayed on the touch screen 106 or 116. At step 1024, tactile input on a third area of the touch screen 106 or 116 corresponding to a first perimeter portion of the second area is received from an associated user. Tactile input on a fourth area of the touch screen 106 or 116 corresponding to a second perimeter of the second area is then received from an associated user at step 1026. The controller 108 or other suitable component associated with the document processing device 104 then forms the second selected redaction area as a generally rectangular area defined by the tactile input in the third and fourth areas of the touch screen 106 or 116 at step 1028. The rectangular area is then generated in accordance with a dragging tactile input between the third and fourth areas of the touch screen 106 and 116 at step 1030.

The controller 108 or other suitable component associated with the document processing device 104 then obfuscates image data corresponding to the second selected redaction boundary area at step 1032. The touch screen display 106 or 116 is then updated at step 1034 such that the image data within the selected area is hidden. It will be appreciated by those skilled in the art that the selected area is capable of being obfuscated via overlaying a solid color block in the selected boundary area, such as a solid black rectangle, a solid white rectangle, or the like. In one such embodiment of the subject application, the rectangular block is color-coded to match the background of the tangible document 122, as will be appreciated by those skilled in the art. The controller 108 or other suitable component associated with the document processing device 104 then appends data in the data storage device 110 to include image data inclusive of the obfuscated image data in the second boundary area at step 1036. Flow then proceeds to step 1020, whereupon a determination is made as to whether to output the redacted document 124. Upon a negative determination, flow returns to step 1022, whereupon another redaction area of the image of the tangible document 122 displayed on the touch screen 106 or 116 is selected by the associated user. Operations then proceed thereon as set forth above with respect to step 1024 through step 1036. When it is determined at step 1020 that the redacted document 124 is to be output, flow proceeds to step 1038. At step 1038, the redacted document 124 is output by the document processing device 104 in accordance with the obfuscated image data corresponding to all redacted boundary areas.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally, and equitably entitled.

What is claimed:

1. A system for selective redaction of scanned documents, comprising:
a scanner;
a memory storing image data from the scanner;
a touch screen display displaying an image of an electronic document from the scanner;
a touch interface of the touch screen operable to define a redaction boundary in accordance with tactile activation of first and second areas relative to a displayed image;
the memory storing image data altered in accordance with a defined redaction boundary; and
a printer operable to print redacted image data.

2. The system of claim 1, further comprising the touch screen operable to define a second redaction boundary in accordance with tactile activation of second and third areas relative to the displayed image, and the memory storing image data altered in accordance with the second redaction boundary area.

3. A method for selective redaction of scanned documents, comprising the steps of:
scanning a tangible document so as to generate electronic image data corresponding thereto;
generating an image of the tangible document on an associated touch screen display in accordance with generated electronic image data;
receiving tactile input on a first area of the touch screen corresponding to a first perimeter portion of a selected redaction boundary area;
receiving tactile input on a second area of the touch screen corresponding to a second perimeter portion of the selected redaction boundary area;
obfuscating image data corresponding to the selected redaction boundary area;
updating the touch screen display such that image data is hidden in the selected redaction boundary area; and
storing image data inclusive of obfuscated image data in the selected redaction boundary area in an associated memory.

4. The method of 3, further comprising the step of forming the selected redaction boundary area as a generally rectangular area defined by tactile input in the first and second areas of the touch screen.

5. The method of claim 4, further comprising the step of generating the rectangular area in accordance with a dragging tactile input between the first and second areas of the touch screen.

6. The method of claim 5, wherein the rectangular area is altered in accordance with the dragging tactile input.

7. The method of claim 3, further comprising the steps of:
receiving selection data corresponding to at least a second selected boundary area;
receiving tactile input on a third area of the touch screen corresponding to a first perimeter portion of a second selected redaction boundary area;
receiving tactile input on a fourth area of the touch screen corresponding to a second perimeter portion of the second selected redaction boundary area;
obfuscating image data in the second selected redaction boundary area;
updating the touch screen display such that image data is hidden in the second selected redaction boundary area; and
appending data in the associated memory to include image data inclusive of obfuscated image data in the second selected redaction boundary area.

8. A system for selective redaction of scanned documents, comprising:
means adapted for scanning a tangible document so as to generate electronic image data corresponding thereto;
means adapted for generating an image of the tangible document on an associated touch screen display in accordance with generated electronic image data;
means adapted for receiving tactile input on a first area of the touch screen corresponding to a first perimeter portion of a selected redaction boundary area;
means adapted for receiving tactile input on a second area of the touch screen corresponding to a second perimeter portion of the selected redaction boundary area;
means adapted for obfuscating image data corresponding to the selected redaction boundary area;
means adapted for updating the touch screen display such that image data is hidden in the selected redaction boundary area; and
means adapted for storing image data inclusive of obfuscated image data in the selected redaction boundary area in an associated memory.

9. The system of 8, further comprising means adapted for forming the selected redaction boundary area as a generally rectangular area defined by tactile input in the first and second areas of the touch screen.

10. The system of claim 9, further comprising means adapted for generating the rectangular area in accordance with a dragging tactile input between the first and second areas of the touch screen.

11. The system of claim 10, wherein the rectangular area is altered in accordance with the dragging tactile input.

12. The system of claim 8, further comprising:
means adapted for receiving selection data corresponding to at least a second selected boundary area;
means adapted for receiving tactile input on a third area of the touch screen corresponding to a first perimeter portion of a second selected redaction boundary area;
means adapted for receiving tactile input on a fourth area of the touch screen corresponding to a second perimeter portion of the second selected redaction boundary area;
means adapted for obfuscating image data in the second selected redaction boundary area;
means adapted for updating the touch screen display such that image data is hidden in the second selected redaction boundary area; and
means adapted for appending data in the associated memory to include image data inclusive of obfuscated image data in the second selected redaction boundary area.
